(19) United States
(12) Patent Application Publication
(10) Pub. No.: US 2002/0116396 A1
(43) Pub. Date: Aug. 22, 2002

(54) System for providing electronic contact information from a central source and method for updating contact information

(76) Inventors: Christopher Somers, Glasgow (GB); Euphemia Isabel Weir Robertson, Blackheath (GB); Oliver Otto, London (GB)

Correspondence Address: BANNER & WITCOFF, 1001 G STREET N W, SUITE 1100, WASHINGTON, DC, 20001, US

(21) Appl. No.: 09/836,547

(22) Filed: Apr. 18, 2001

Related U.S. Application Data
(60) Provisional application No. 60/270,167, filed on Feb. 22, 2001.

(51) Int. Cl. G06F 12/00

(52) U.S. Cl. 707/200

(57) ABSTRACT

A system and method for providing current information to authorized individuals or entities. The present invention contemplates an originating individual providing an initial electronic version of the originating individual's information (e.g., work address, work telephone number, etc.) to a receiving party. This can be done, for example, by data link between respective electronic data devices, such as personal digital assistants. The originating individual's information is also stored at a accessible site, such as a server on a data network. Changes to the originating individual's information are stored at the accessible site. Thereafter, the receiving party periodically accesses the accessible site to obtain a current version of the originating individual's information. A security mechanism may be provided so that the originating individual can control dissemination of his information.

### In accordance with 35 U.S.C. §119(e)(1), this application claims priority from Provisional U.S. Appln. No. 60/270,167, filed on Feb. 22, 2001.

### FIELD OF THE INVENTION

The present invention relates to an information exchange system. More particularly, the present invention relates to updating contact information through a remote source.

### BACKGROUND OF THE INVENTION

Physical business cards, calling cards, and the like (made from, for example, paper or plastic) are ubiquitous. Such cards typically provide personal contact information such as the card giver's name, title, business and/or personal address, office and/or home telephone number, facsimile number, and cell phone number. However, because such information is permanently fixed to each card, the cards frequently become partly or entirely out of date or otherwise obsolete. For example, an individual's job title may change, or that individual may be physically relocated within a company such that the relevant telephone and/or facsimile numbers change. So, when giving a business card or calling card to another, one typically needs to write on the card to correct or obliterate the incorrect information. Also, the information conveyed is limited to that already appearing on the card. Therefore, an individual who may want to additionally provide, for example, his home telephone number, must handwrite it on the card. However, he may not have a writing implement available to write additional information, or his handwriting may be comparatively unintelligible.

Also, conventional physical business cards are notoriously inconvenient to handle (especially when received in large numbers, such as during a business convention) and are very prone to being lost. Conversely, an individual may unexpectedly run out of individual business cards at a large gathering (such as a business convention). In this situation it is at least very difficult and/or expensive to obtain additional business cards, and it is sometimes completely impossible to do so.

Electronic business cards are also known. For example, the PALM™ OS 3.x permits users to designate one address stored in a PALM™ personal data assistant (or PDA) as one's electronic business card. One then is free to transmit this business card to others. Provided that the owner (or author) of the electronic business card to be transmitted has kept the business card's information current, the recipient knows that the information should be current when received. Nonetheless, this electronic information may quickly become stale like that of printed business cards.

### SUMMARY OF THE INVENTION

The present invention alleviates the problem of stale business cards. The invention also alleviates the problem of stale directories (for example this could be employee databases or client directories). The invention is also applicable to non-business related contact information. The present invention includes providing initial contact information to a recipient with the recipient being selectively permitted to later update the received information from a remote source.

In a second aspect of the invention, the recipient is provided with a token to retrieve the remotely stored contact information. In this second aspect, the recipient does not receive all of the available contact information but receives a subset or merely a token or pointer to where the remotely stored information may be obtained.

In a third aspect of the invention, the recipient may update the received contact information to ensure that the recipient's information is current. The updating may occur once, periodically, when desired, and at other times as well.

For example, one individual may offer another individual his or her information in electronic form. If any changes, additions, or deletions are made to the information, the person who offered the information stores that changed information at an accessible location (such as a remote server). Thus, the receiving individual may then retrieve the current information from the accessible location, such that the receiving individual will have current information about the offering individual.

### BRIEF DESCRIPTION OF THE DRAWINGS

Embodiments of the present invention are understood with reference to the drawings appended hereto, in which:

FIG. 1 is a flow chart illustrating, broadly, the process of providing current information to a requester;

FIG. 2 illustrates a network topology for providing functionality according to the present invention; and

FIG. 3 illustrates certain details of a network configuration for providing functionality according to the present invention.

### DETAILED DESCRIPTION OF THE EMBODIMENTS

The present invention is described in view of various embodiments. These embodiments are not intended to be limiting. The elements and steps of the present invention are found in the claims.

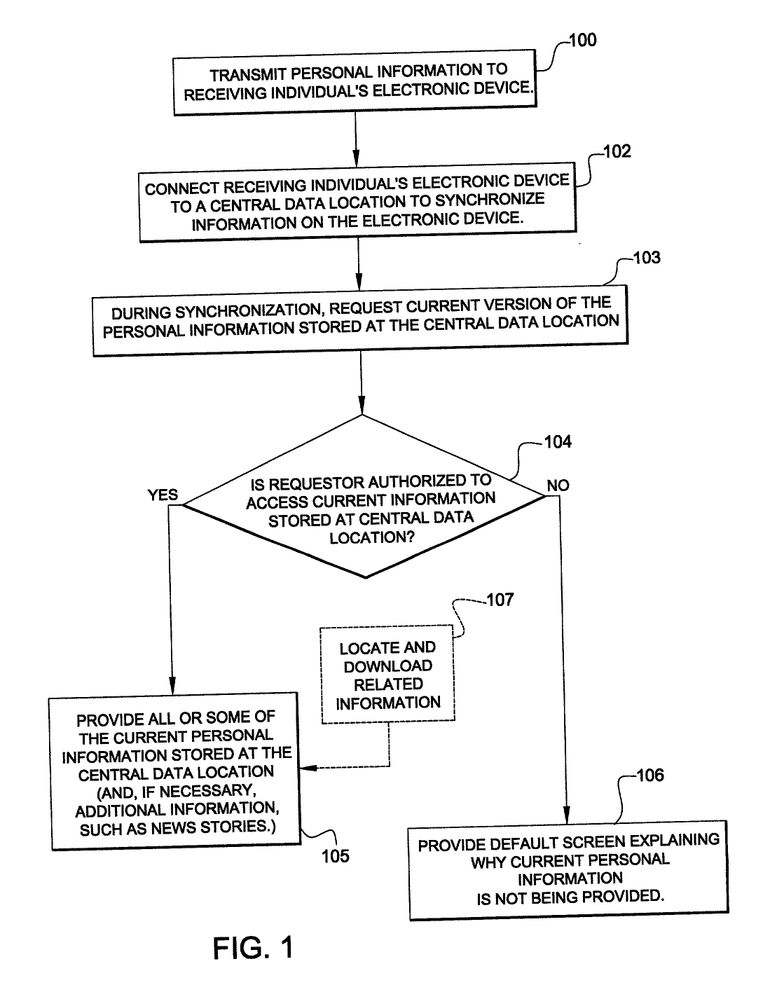

FIG. 1 is a flow chart illustrating a general process flow of data. One individual (i.e., an originating individual or originator) electronically provides another individual (i.e., the receiving individual or recipient) with his or her information in step 100. The information is transmitted from the originating individual to the receiving individual by transmitting the information from an electronic device belonging to the originating individual to an electronic device belonging to the receiving individual. The receiving individual may synchronize the received information with current information available at a remotely accessible site as shown in step 102. During synchronization, the current version of information is requested in step 103. The remote site determines whether the requestor (i.e. the receiving individual) is authorized to access the information stored at the remote site in step 104. If permissions have been granted, some or all of the information about the originating party is provided in step 105. If permissions have not been granted, the system informs the user that the contact information is not being provided (step 106).

In one embodiment, at least some information may be transmitted between personal data assistants (such as those commercially available under brand names such as Palm™, Blackberry™, Handspring™, Psion™, Cassiopeia™, and PocketPC™ (Cassiopeia, Jornada, and iPaq are three PDAs that use the PocketPC operating system) by way of a conventional infrared data interface. Other electronic devices may be used as well in any combination, including palmtop computers and Internet-enabled wireless telephones with data organizing functionality (these are known as smart phones and represent a convergence of PDAs and mobile phones). This exchange of electronic information takes place instead of, for example, the conventional exchange of paper business cards. The transmitting process may take a variety of forms including wireless transmissions (including infrared-based and radio-based) and wired transmissions (via a cable). Further, the transmission of the information may occur via email, transmissions to a web site, short IP messages to a device and the like. Alternative transmission paths include the SMS text messaging part of the GSM mobile phone protocol, and the Bluetooth protocol (i.e., a radio frequency based protocol).

The transmitted information may be provided in any suitable data format. In one example, the conventional vCard data format is used.

The embodiments described herein reference personal digital assistants (PDAs). However, it is expressly noted that other types of electronic devices can be also used according to the present invention including, without limitation, palmtop computers, desktop computers, laptop computers, and Internet-enabled wireless telephones having data organizing functionality.

In a first example, after receiving the transmitted information from the originating individual, the receiving individual has an initial version of the originating individual's information. As mentioned above, this information may include conventional information items, such as, without limitation, the originating individual's name, title, business address, telephone number, fax number, cell phone number, email address, and business and/or personal web site. The type of information items provided in block 100 may be customized as desired. The information included may also be third party data that may be optionally included with the rest of the profile (see step 107). One example of this is news headlines or other information relevant to a company or industry that are included with the personal information. This data can be updated regularly independent of the originator who only has to select a particular news feed when he set up the card. Thus, when the recipient of the profile looks at the contact data she can also see the latest, for example, news headlines about that person or company.

In a second example, the information passed to the receiving individual is less than all information available to be transmitted. For example, the originator may only transmit his name and organization to the receiving individual. This information may be accompanied by a token permitting access to a location storing the remainder of the originator's information. Further, the token may include a pointer to the storage location.

In a third example, the originator may desire to selectively permit certain types of information to be exchanged. Here, the originator may have a variety of tokens passable to the receiving individual. A first token may permit all of the originator's information to be later obtained. A second token may permit only business information to be obtained (for example, the place of business, work telephone number, work email and the like). A third token may permit only personal information to be obtained including home telephone number, home fax number, home address, home email, and the like. It will be appreciated that any number of tokens may be used with each having a different set of information that may 1) be included with the token and 2) permit remote updating of information. In this regard, at least three tokens may be assigned as work tokens. The first work token may include current work information and permission to permit the recipient of the token to update the work information. The second work token may include only the permission (and other related information) to retrieve the work information. The third work token may include some work information with the permission to retrieve additional work information from the accessible source.

Although ‘work’ token is a useful shorthand to describe the subset of information that the recipient is entitled to it should be stressed that the subset of information will be entirely for the originator to choose and not based on some predefined groups of data. The token will be determined by the information rather than the other way round. For example, the originator will choose which data fields should be passed on and the permission token will then be based on those fields indicating that they are to be accessible.

In the above examples, the originator of the information may also include a designation of the expiration of the token. So, for example, the originator may providing work information to the recipient but permit the recipient's received information to become stale after a designated period of time. This ability to permit tokens to expire permits the originator of the information to control who has access to the information and over what period. For example, if one were seeking estimates from builders, one would only have a temporary interest in providing information to the builders. So, even though builders may receive information from the originator, the information would be permitted to become stale. In a further example, the originator may permit the token to, in effect, self destruct and eliminate the originator's information from the recipient's collection of information.

The token is currently an entry in a data field that indicates to the server what other information fields the recipient is entitled to access. The token is meta data and is included with the other data. The token could be transferred on its own with the other data fields empty so that after synchronization the correct fields would then be filled in. The token may be encrypted data so that it is unreadable except by an authorized user. The underlying data may be included as part of this encrypted data to make it secure and stop unauthorized transfer of the data.

As mentioned above, information about the originating individual may change over time. For example and without limitation, the originating individual's name may change because of marriage or divorce. The individual's title may change because of a promotion, his business address may change because of a move, or his cell phone number may change because he lost his cell phone. As a result, the initial version of electronic information possessed by the receiving individual becomes out of date or otherwise inaccurate.

The present invention conveniently addresses this problem by taking advantage of the ability to periodically “synchronize” or “sync” a data assistant (or other data organizing device) with a parent computer (for example, a home or office computer). Synchronization is conventionally carried out so that, for example, appointment entries entered into the data assistant during the course of a day can be made to conform with a master scheduling calendar stored on, for example, an office computer. Synchronization is generally a known process in the field of electronic data organizers (such as personal digital assistants), so only a general description, emphasizing aspects particularly associated with the present invention, is provided here.

There are a number of services that rely on synchronization (e.g. AvantGo) and a number of software solutions that provide synchronizing technology for specific devices (HotSync for Palm, Active Sync for PocketPCs). For example, to use AvantGo the software relevant to a given PDA is downloaded, then ‘channels’ (which are web sites specially configured to be displayed on a PDA) are selected. When synchronization occurs, the software recognizes the selected channels and makes a connection (if it can) over the Internet to the AvantGo server. The software uses the user's login to detect user preferences and then downloads the latest versions of the selected channels to the PDA. There is a checking mechanism to stop a redundant download of channels that have not altered since the last sync. Once the download is complete the synchronizer disconnects from the server and any other syncing processes that remain for the PDA are completed. AvantGo runs on top of standard synchronization tools, e.g. HotSync. The present invention may operate on top of such tools in a similar manner.

A version of the originating individual's information is stored at a remotely accessible location. When the originating individual's information changes, that changed information is provided to the accessible site. For example, the originating individual may periodically review and update his stored information. The review process may occur by the originating individual accessing the remotely stored information.

Alternatively, the originating individual may make local changes to the information he has on his PDA or other device and sync this information with the remotely accessible site. As above, the synchronization may occur in conjunction with other synchronization processes. Only the originating individual may update his details (i.e. appropriate security measures will be in place to ensure this, for example and without limitation, username and password login or Public Key Infrastructure (PKI).

In a specific example, the originating individual gives his or her information to the receiving individual by data exchange between digital assistants or other electronic devices by way of, for example, a conventional infrared data interface between the devices. The receiving individual can thereafter access the accessible site to receive a current version of the offered information, for example, during the conventional process of “synchronizing” data on a personal digital assistant with, for example, a home or office computer or other similar data organizing device.

The dissemination of an offering individual's information can be controlled. Access to the information can be controlled by associating an information access authorization level with a requester requesting the current information from the accessible site. In another aspect of the present invention, the offering individual can control access to his or her current information by utilizing access control mechanisms at the accessible site. For example, the offering individual can identify certain individuals who are allowed only partial access to current information, or other individuals who are barred from receiving the current information.

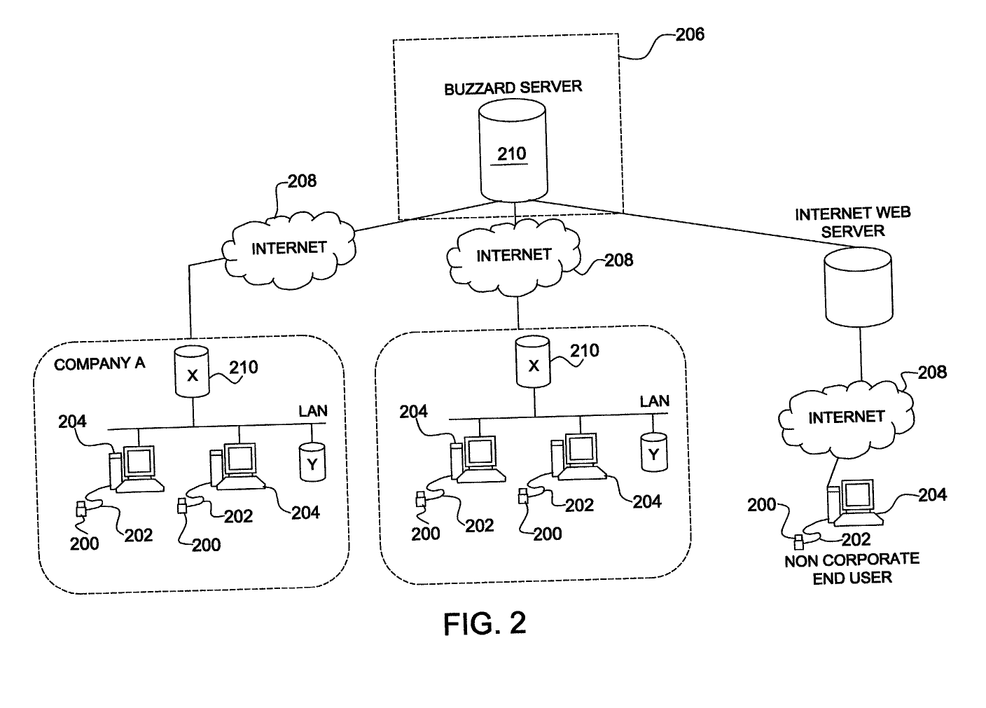

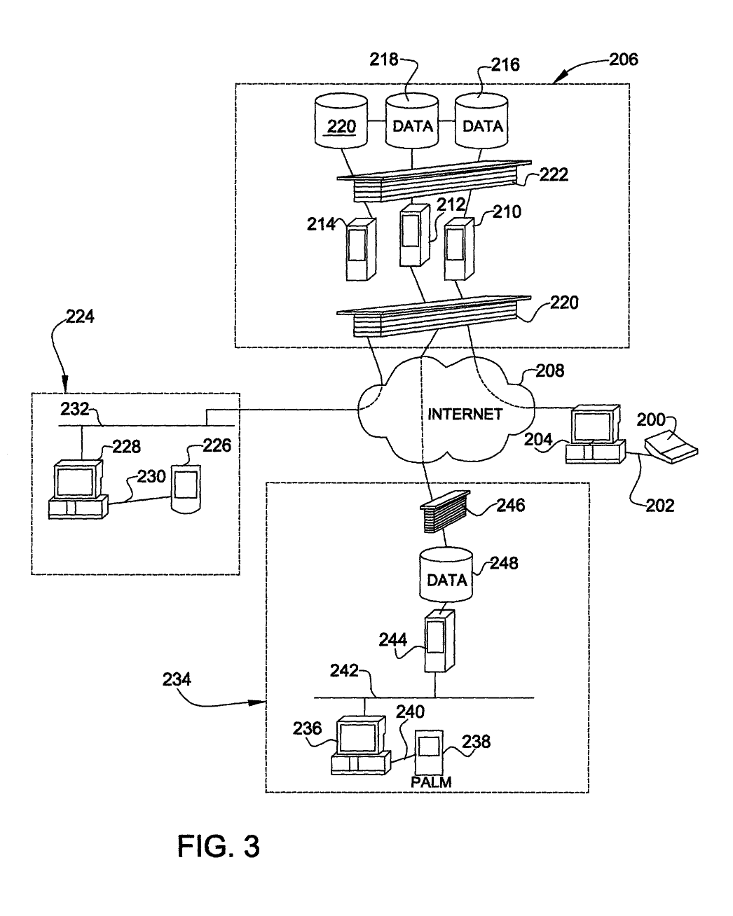

Therefore, from the receiving individual's viewpoint, synchronization of his electronic device additionally includes operably connecting the electronic device to an accessible site (block 102 in FIG. 1, element 206 in FIGS. 2 and 3). In one example of the present invention, the receiving individual's electronic device 200 is connected to a desktop computer 204 by, for example, a standard data interface cable 202. The desktop computer 204 is in turn connected to accessible site 206 by way of, for example, a client-server data network. In one example of the present invention, the client-server data network may be the Internet 208 and the connection between desktop computer 204 and the Internet 208 may be of any conventional type, such as dial-up modem, DSL, etc.

The accessible site 206 may include at least one server 210 operably connected to the Internet 208 and to data storage 216.

The user interface for manipulating information located at accessible site 206 is, for example, an interactive world wide web site. The web site functionality may, for example, be provided by server 210. If desired, network firewalls 220 and 222 may be provided between the accessible site 206 and the Internet 208 and/or between server 210 and data storage 216, and operated in a known manner in accordance with network data security concepts.

Thus, as part of the process of synchronizing electronic device 200, a data connection is established between desktop computer 204/electronic device 200 and server 210. In one example, server 210 downloads the current information for the originating individual (which is stored in data storage 216) to desktop computer 204 and, in turn, electronic device 200 (for example, in response to a conventional client-server request). In addition, the server 210 may provide additional information items, beyond what is originally stored in electronic device 200. (For example, it may be desirable to provide an expanded amount of information that will be stored on desktop computer 204 because of limitations on the initial amount of information that can be stored on electronic device 200.)

In practice, it is desirable to permit the originating individual to control dissemination of his information and otherwise maintain the security of that information. This may include, without limitation, according a given receiving individual who wants to download current information from server 210 a certain level of access authorization. For example, a given receiving individual may only be authorized to view certain information (for example, business related information such as work address and work telephone number) and not other information (for example, contact information such as home address and home telephone number).

According to one aspect of the present invention, therefore, dissemination of information can be controlled by providing a given receiving individual an electronic information access authorization token when the originating individual's information is first transmitted to the receiving individual. The access token may be any known data structure, such as, without limitation, a cookie or a data packet, containing details about the level of access accorded to the receiving individual.

The token may be encrypted data readable by the central server that will identify the following: which data fields are accessible, which data feeds are accessible, when the token was created (i.e. when the data was first passed to the recipient and a ‘time to live’counter indicating how long (if appropriate) the token will remain valid.

According to another aspect of the present invention, the originating individual may selectively control access to his information by using access control mechanisms at server 210. For example, the originating individual could use another desktop computer 204 to access the web site for controlling server 210. In this regard, it should be remembered that a receiving individual may transmit the originating individual's information on to other entities, such that a “downstream” entity may seek further access to the originating individual's information. Therefore, when any individual or entity accesses accessible site 206, it may be useful to require them to identify themselves (for example, by a pre-access registration process, as is conventionally known). Thus, access to the information stored at accessible site 206 can be controlled by selectively setting access permissions for certain individuals or entities and/or by comparing the identity of the individual or entity requesting information with the aforementioned access token (which, for example, may include the identity of the individual to whom the access token was initially given). The ability to perform such controls may be secured by requiring an originating individual to enter a password or other pass code before manipulating access control mechanism at accessible site 206.

The foregoing describes embodiments for use by an individual. However, the present invention will be useful for both small and large businesses. Both of these embodiments are described below.

For a small business system 224, the basic arrangement of an electronic device 226 connected to, for example, a desktop computer 228 (using standard interface 230) is similar to the individual user case. However, the small business may have one or more computers 228 connected to a network backbone (for example, to define a local or wide area network). The backbone 232 is in turn connected to the Internet 208 and server 214 in a known manner. Thus, except for the differences in the networking architecture noted here, the operation of the small business system is substantially identical to the operation of the individual user system discussed above. A detailed description thereof is therefore omitted here, except to note that the user interface functionality of, for example, an interactive web site particularly associated with the small business may be provided on a unique server 214 at the accessible site 206. Server 214 is “unique” in that it is independent from, for example, a standard server 210 used by individual users, and may contain special content particularly associated with the small business. Also, making server 214 unique and/or independent may increase network security for the information handled by the small business.

A third embodiment relates to a system for use by a comparatively large business, as seen at 234. At a basic level, a desktop (or laptop) computer 236 is coupled, as needed, with an electronic device 238 by way of a standard interface 240. One or more computers 236 are connected by way of a network backbone 242. In this embodiment, however, the large business may operate its own web site, resident on its own server 244. Therefore, users in the large business use the user interface provided at the company's web site on server 244. Again, the company's own web site may use content specific to that company. In turn, server 244 is operably connected to a data network such as the Internet 208, as shown. If desired, a firewall 246 can be provided operably between the large business system and the Internet 208 in a manner in accordance with known network data security concepts.

Server 244 therefore interacts across Internet 208 with a corresponding server 212 at accessible site 206. In turn, server 212 manipulates stored information stored in data storage 218 as needed.

It may be useful for a business system to include a local database 248 in order to store and further organize information records collected by the business for internal business use, such as creating client lists or lists of potential clients. The present invention includes, for example, internally compartmentalizing information records. For example, one sales team may be internally in competition with another sales team, so that each team's collected information should not be shared. In this regard, the use of a local database also is applicable to the small business system 224.

For business systems, additional features may be provided. For example, if a given employee leaves the business, a network administrator or like individual may set the business's server to respond to a request for the former employee's information by providing a default data record. The data record may, for example, contain a short text message stating that the employee is no longer working for the business and suggesting an alternate contact within the company.

In general, the functionality of the present invention may be provided as a paid subscription service, wherein a subscriber (corresponding to one or more originating individuals as discussed above) obtain control access to accessible site 206 on a paid basis. Receiving individuals would generally not have to pay to request current information from accessible site 206, although they may desirably have to identify themselves in a pre-access registration process. Also, it may in some cases be necessary for receiving individuals to initially download appropriate software and/or browser plug-ins in order to access the system according to the present invention.

If an originating individual has changes in his data, a receiving individual may have access to archived data. For example, if an individual is promoted at his job, a receiving individual may be able to see that a change has taken place because the receiving individual can compare old and new information.

A receiving individual may be able to add customized fields to the profile. These fields will not be overwritten when the receiving individual synchronizes with the central server, but on the other hand, the fields will not be transferred to the central server, i.e., the centrally stored profile will not change.

Any kind of data may be stored on the profile, (e.g. a photo of the profile owner (i.e., the originating individual), an audio file containing the pronunciation of his name, etc.). This aspect of the invention is only limited by the technical capability of the electronic device.

The profile may be viewed on a proprietary application on the PDA. It may also be viewed in the standard address book of the device or in the address book of groupware applications, but in these cases functionality may be limited, (e.g., updates may only be possible if the profile is stored in the proprietary application, or certain fields may not be available in the address book).

In another example, the present invention is usable in a telephone call center environment. Conventionally, incoming calls are queued and then routed to a first available call operator (for example, a sales representative). Thus, a caller necessarily rarely (if ever) speaks to the same individual(s) that he or she spoke to on a prior call. In conjunction with the present invention, however, a caller may be provided with updated information identifying, for example, a given call operator's current work schedule, so that same call operator can be deliberately sought out by the caller. Similarly, the information provided to the caller may including information about a primary call operator, including, for example, identifying a designated alternative contact to be contacted by the caller in the absence of the primary call operator. Also, the information provided to the caller may identify several call operators who each work on a given part of a company's business (e.g., in a particular business department), so again, a specific call operator can be sought out by a caller.

Thus, while there have been shown and described and pointed out fundamental novel features of the present invention as applied to preferred embodiments thereof, it will be understood that various omissions and substitutions and changes in the form and details of the devices illustrated, and in their operation, and in the method illustrated and described, may be made by those skilled in the art without departing from the spirit of the invention as broadly disclosed herein.

We claim:

1. A method for obtaining information, comprising:
electronically obtaining and storing information in an electronic device;
establishing a data connection between the electronic device and a accessible site having a current version of the information stored thereat; and
updating the information stored in the electronic device by providing the electronic device with the updated information stored at the accessible site by way of the data connection.

2. The method according to claim 1, wherein electronically obtaining and storing information in an electronic device comprises receiving the information from another electronic device.

3. The method according to claim 1, wherein said electronic device is an electronic data organizer.

4. The method according to claim 3, wherein said electronic data organizer is a digital assistant.

5. The method according to claim 3, wherein said electronic data organizer is one of a palmtop computer system, a laptop computer system, and a desktop computer system.

6. The method according to claim 1, wherein said electronic device is an Internet-enabled wireless telephone including an electronic data organizer.

7. The method according to claim 2, wherein receiving the information from another electronic device comprises wirelessly receiving the information.

8. The method according to claim 1, wherein the accessible site is a server on the Internet, wherein establishing a data connection between the electronic device and an accessible site comprises establishing an Internet connection between the electronic device and the server by way of the Internet.

9. The method according to claim 1, further comprising restricting dissemination of the updated information in correspondence with the identity of an individual seeking the updated information.

10. The method according to claim 9, wherein obtaining and storing information in an electronic device comprises receiving an information access authorization data token along with the information.

11. The method according to claim 9, wherein a predetermined portion of the updated information is provided to the electronic device in correspondence with the identity of the individual seeking the updated information.

12. The method according to claim 10, wherein a predetermined portion of the updated information is provided to the electronic device in correspondence with a level of information access authorized by the information access authorization data token stored on the electronic device.

13. The method according to claim 9, wherein a default data record is provided to the electronic device in correspondence with the identity of the individual seeking the updated information.

14. The method according to claim 10, wherein a default data record is provided to the electronic device in correspondence with a level of access authorized by the information access authorization data token stored on the electronic device.

15. The method according to claim 1, wherein more updated information is provided than the amount of the original information stored.

16. The method according to claim 1, wherein less updated information is provided than the amount of the original information stored.

17. A method of providing current information, comprising:
maintaining current information at an accessible site; and
supplying the current information to a requestor upon demand by the requester.

18. The method according to claim 17, wherein maintaining current information comprises replacing originally stored information stored at the accessible site with subsequently stored information.

19. The method according to claim 18, wherein the information is a combination of information created by an individual to whom the information pertains and third individual content.

20. The method according to claim 17, wherein the accessible site is a server on a data network and the requester demands current information from the server using a client device on the data network.

21. The method according to claim 20, wherein the data network is the Internet.

22. The method according to claim 17, further comprising identifying the requestor, and supplying the current information in accordance with a level of access accorded to the identified requestor.

23. The method according to claim 22, further comprising detecting an information access authorization data token included in the requestor's demand, wherein supplying the current information in accordance with a level of access accorded to the identified request or comprises supplying the current information in accordance with a level of access accorded to the information access authorization data token.

24. The method according to claim 22, wherein supplying the current information in accordance with a level of access accorded to the identified requester comprises supplying only a predetermined portion of the current information to the requester.

25. The method according to claim 23, wherein supplying the current information in accordance with a level of access accorded to the information access authorization data token comprises supplying only a predetermined portion of the current information to the requestor.

26. The method according to claim 22, wherein supplying the current information in accordance with a level of access accorded to the identified requestor comprises supplying a default information record to the requester instead of the current information.

27. The method according to claim 23, wherein supplying the current information in accordance with a level of access accorded to the information access authorization data token comprises supplying a default information record to the requestor instead of the current information.

28. The method according to claim 26, wherein the default information record contains text indicating to the requestor that the requestor is not authorized to receive the current information.

29. The method according to claim 27, wherein the default information record contains text indicating to the requester that the requester is not authorized to receive the current information.

30. A client-server data network for providing current information stored on a server to a client, comprising:
an information server constructed and arranged to store current information; and
at least one client constructed and arranged to do at least one of provide current information to said information server for storage and request stored current information stored on said information server, said at least one client being at least occasionally electronically connected to said information server.

31. The network according to claim 30, wherein said at least one client comprises one of a desktop computer, a laptop computer, a palmtop computer, and an Internet-enabled wireless telephone.

32. The network according to claim 31, wherein said at least one client includes a data interface for establishing a data connection with a digital assistant.

33. The network according to claim 30, comprising a plurality of electronically interconnected said clients associated with a gateway server, wherein said plurality of clients are connected to said information server by way of said gateway server.

34. The network according to claim 30, further comprising a local information database associated with said at least one client, said database being constructed and arranged to store at least one of current information provided to said information server and stored current information obtained from said information server.
